(19) United States
(12) Patent Application Publication
(10) Pub. No.: US 2026/0285009 A1
(43) Pub. Date: Sep. 24, 2026

(54) HIGH-TEMPERATURE MULTILAYER INSULATION

(71) Applicant: Blue Origin Manufacturing, LLC, Huntsville, AL (US)

(72) Inventors: Matthew Adkins, Seattle, WA (US); Christopher H. Baker, Centreville, VA (US); Benjamin I. Furst, Tujunga, CA (US); Roberta Michelle Frey, Gilbert, AZ (US)

(21) Appl. No.: 19/083,754

(22) Filed: Mar. 19, 2025

(51) Int. Cl. B32B 15/09; B32B 3/30; B32B 27/28; B32B 27/36

(52) U.S. Cl. CPC B32B 15/09; B32B 3/30; B32B 27/281; B32B 27/36; B32B 2307/304

(57) ABSTRACT

Systems and methods for thermal insulation that can operate at relatively high temperatures are presented. The insulation may be high-temperature multilayer insulation (MLI) that can operate at refractory temperatures. The High-temperature MLI uses refractory metal foils for the layers that are closest to the heat source. A high-temperature scrim and/or other types of insulation may be disposed between or among the foil layers to provide additional insulation. Generally common materials may be used for the MLI closest to the cool side. The MLI materials may be multiple layers of thin, lightweight reflective films comprising polyimide and/or polyester films, such as Mylar or Kapton, which may be vapor deposited with high-purity aluminum on one or both sides. The high-temperature MLI may provide thermal insulation for relatively high temperatures while being much lighter and having substantially less volume than other types of insulation that can withstand the high temperatures.

### BACKGROUND

High-temperature processes, particularly those at temperatures reaching 2000° C. or so, present a significant challenge in the field of thermal insulation technology. Traditional blanketing insulation, a common solution for thermal management, generally fails to perform effectively at such extreme temperatures. The intense heat may overcome the thermal resistance of these blanketing materials, leading to rapid degradation and, ultimately, insulation material failure. This limitation poses a substantial obstacle in environments where high-temperature insulation is important.

Moreover, alternative insulation materials capable of withstanding higher temperatures often come with their own set of drawbacks. These materials, while thermally robust, tend to be excessively heavy or voluminous, making them less suitable for applications where weight and volume are critical factors, such as in space travel or lunar or planetary activities. Consequently, there is an ongoing need for thermal insulation that is capable of withstanding very high temperatures while having relatively low mass and low volume.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is schematic cross-section diagram of a vessel containing molten material and surrounded by thermal insulation, according to some embodiments.

FIG. 2 is schematic cross-section diagram of a vessel containing molten material and surrounded by thermal insulation, according to other embodiments.

FIG. 3 is schematic cross-section diagram of a portion of thermal insulation, according to some embodiments.

FIG. 4 is a front view of a layer of thermal insulation, according to some embodiments.

FIG. 5 is a schematic cross-section diagram of a portion of thermal insulation, according to some embodiments.

FIG. 6 is a close-up view of a ceramic button portion of thermal insulation, according to some embodiments.

### DETAILED DESCRIPTION

This disclosure describes systems and methods for thermal insulation that can operate at relatively high temperatures. In particular, such insulation may be high-temperature multilayer insulation (MLI) that can operate at refractory temperatures, which are generally above 1000 degrees Celsius. The High-temperature MLI uses refractory metal foils for the layers that are closest to the heat source. A high-temperature scrim and/or other types of insulation may be disposed between or among the foil layers to provide additional insulation and/or structural stability. Generally common materials may be used for the MLI closest to the cool side (e.g. farthest from the heat source). For example, common MLI materials may be multiple layers of thin, lightweight reflective films comprising polyimide and/or polyester films, such as Mylar or Kapton, which may be vapor deposited with high-purity aluminum on one or both sides. The number of such layers may vary, typically ranging from 5 to 30 layers, for example. The High-temperature MLI may be used in environments where thermal (e.g., IR) radiation is the dominant mechanism for heat transfer, such as in spacecraft and other applications in vacuum.

Benefits of high-temperature MLI described herein are that it may provide thermal insulation for relatively high temperatures while being much lighter and having substantially less volume than other types of insulation that can withstand the high temperatures.

Generally, a metal foil is a very thin sheet of metal, typically made by a rolling process that compresses the metal into extremely thin layers. Foils may have a thickness of up to about 200 microns, though claimed subject matter need not be limited to foils having a particular thickness or range of thicknesses.

In some embodiments, a high-temperature MLI may include a hot zone portion, a mid-temperature zone portion, and a low temperature zone portion. Such designations are merely for descriptive purposes and may generally describe thermal conditions in the respective zones. Though claimed subject matter is not limited in this respect, the hot zone portion may be configured to operate at temperatures above about 1000 degrees Celsius, the mid-temperature zone portion may be configured to operate at temperatures between about 1000 and 400 degrees Celsius, and the low temperature zone portion may be configured to operate at temperatures below about 400 degrees Celsius.

Refractory metal foil layers may be disposed in the hot zone portion. An insulating transition layer may separate the hot zone portion and the mid-temperature zone portion. Non-metal substrate layers (e.g., Kapton or Mylar with metal coatings) may be disposed in the mid-temperature zone portion and/or the low temperature zone portion. A metal thread (which may be a refractory metal) that penetrates at least some of the refractory metal foil layers may be configured to at least partially hold the refractory metal foil layers together. A ceramic button may be disposed on the insulating transition layer and may be configured to retain a termination of the metal thread, as described below. In some implementations, the high-temperature MLI may include, instead of or in addition to a metal thread, a ceramic rod that penetrates at least some of the refractory metal foil layers and is configured to at least partially hold the refractory metal foil layers together. The high-temperature MLI may further include a zirconia felt layer between the refractory metal foil layers. The zirconia felt layer may include apertures to reduce the mass of the zirconia felt layer.

In some embodiments, a high-temperature MLI may include refractory metal foil layers, non-metal substrate layers, and one or more insulating transition layers separating the refractory metal foil layers and the non-metal substrate layers. The high-temperature MLI may also include metal threads (e.g., molybdenum or other refractory metal) that penetrate at least some of the refractory metal foil layers and may be configured to at least partially hold the refractory metal foil layers together. A ceramic button disposed on an insulating transition layer may be used to retain an end of the metal thread. In some implementations, the MLI may include a ceramic rod that penetrates at least some of the refractory metal foil layers so as to at least partially hold the refractory metal foil layers together.

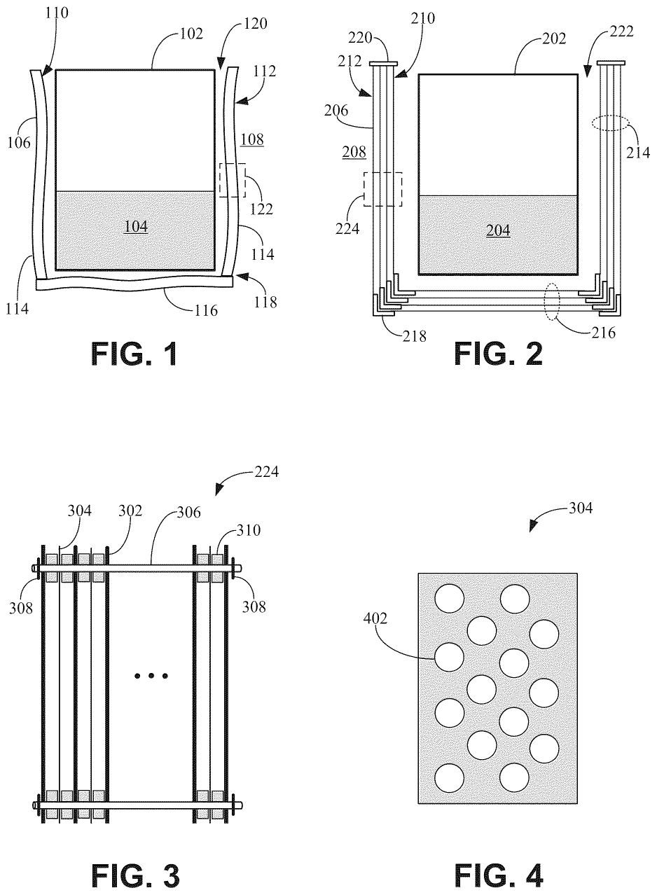

FIG. 1 is schematic cross-section diagram of a vessel 102 partially filled with molten material 104 and at least partially surrounded by thermal insulation 106, according to some embodiments. Relative sizes in the figure are not necessarily drawn to scale and may be exaggerated for clarity. Insulation 106 may be a high-temperature insulation that can withstand refractory temperatures greater than 1000 degrees Celsius, for example. To illustrate this capability, vessel 102 may be made of a refractory material and may contain molten material 104 such as molten silicon at a temperature greater than about 1450 degrees Celsius. An ambient temperature 108 just beyond insulation 106 may be much cooler (e.g., less than 100 degrees Celsius). For example, the relatively cooler region just beyond the insulation may include various equipment or instrumentation that generally is not able to withstand the high heat that may be just on the other side of insulation 106. The temperature difference between the two sides of insulation 106 leads to a heat transfer in the direction of decreasing temperature. Portions 110 of insulation 106 that are nearest to molten material 104 will also be nearest to the temperature of the molten material. Portions 112 of insulation 106 that are farthest from molten material 104 will generally be substantially cooler than the temperature of the molten material, based on the effectiveness of the insulation and ambient temperature 108. Accordingly, as described below, portions 110 nearest to the hot side of the insulation may comprise materials that can withstand very high temperatures. In contrast, portions 112 farthest from the hot side of the insulation need not comprise materials that can withstand the high temperatures and may thus be materials selected for, among other things, their relative lightness and low volume. For example, portions 110 may comprise refractory metal foils and portions 112 may comprise lighter nonmetallic substrate layers.

Insulation 106 may be pliable and may be described as being a blanket insulation. This pliable property may allow insulation 106 to be wrapped around and conform to objects that are to be insulated. Additionally, insulation 106 may be applied to an object (e.g., vessel 102) in more than one piece or section. For example, insulation 106 may include a side portion 114 and a bottom portion 116 that have a joint 118 where they meet. Insulation 106 may be in contact with vessel 102 or may be separated by a space 120. These are merely a few example details and claimed subject matter is not so limited. A portion 122 of insulation 106 is indicated in the figure and will be described below.

FIG. 2 is schematic cross-section diagram of a vessel 202 partially filled with molten material 204 and at least partially surrounded by thermal insulation 206, according to some embodiments. Relative sizes in the figure are not necessarily drawn to scale and may be exaggerated for clarity. Insulation 206 may be a high-temperature insulation that can withstand refractory temperatures greater than 1000 degrees Celsius, for example. To illustrate this capability, vessel 202 may be made of a refractory material and may contain molten material 204 such as molten silicon at about 1450 degrees Celsius. An ambient temperature 208 just beyond insulation 206 may be much cooler (e.g., less than 100 degrees Celsius). The temperature difference between the two sides of insulation 206 leads to a heat transfer in the direction of decreasing temperature. Portions 210 of insulation 206 that are nearest to molten material 204 will also be nearest to the temperature of the molten material. Portions 212 of insulation 206 that are farthest from molten material 204 will generally be substantially cooler than the temperature of the molten material, based on the effectiveness of the insulation and ambient temperature 208. Accordingly, as described below, portions 210 nearest to the hot side of the insulation may comprise materials that can withstand very high temperatures. In contrast, portions 212 farthest from the hot side of the insulation need not comprise materials that can withstand the high temperatures and may thus be materials selected for, among other things, their relative lightness and low volume. For example, portions 210 may comprise refractory metal foils and portions 212 may comprise lighter nonmetallic substrate layers.

Insulation 206 may comprise a number of layers, which may be refractory metal foils, for example. Insulation 206 may wrap around and conform to objects that are to be insulated. Additionally, insulation 206 may be applied to an object (e.g., vessel 202) in more than one piece or section. For example, insulation 206 may include a side portion 214 and a bottom portion 216. Layers of each portion may terminate and be supported by ceramic corner clips 218 and a top support 220. Insulation 206 may be in contact with vessel 202 or may be separated by a space 222. These are merely a few example details and claimed subject matter is not so limited. A portion 224 of insulation 206 is indicated in the figure and will be described below.

FIG. 3 is schematic cross-section diagram of portion 224 of thermal insulation 206, according to some embodiments. Relative sizes in the figure are not necessarily drawn to scale and may be exaggerated for clarity. Thermal insulation 206 may include multiple refractory metal foil layers 302 that may alternate with an intermediate insulation layer 304, which may be zirconia felt and/or a high-temperature scrim (e.g., a loosely woven fabric comprising fibers that can withstand high temperatures), for example. Molybdenum lanthanum layers (e.g., foils) may also, or instead, be disposed among foil layers 302. Molybdenum lanthanum contains a relatively small amount of lanthanum oxide in molybdenum. Refractory metal foil layers 302 may be tantalum, tungsten or zirconia foils. Ceramic through-bolts 306 may penetrate layers 302 and 304 to maintain mechanical dimensions (e.g., spacings between adjacent layers) and to provide structural stability. Ceramic through-bolts 306 may axially retain layers 302 and 304 therebetween with terminations 308 at or near distal ends of the through-bolts. Insulation pads 310, which may be made of the same material as intermediate insulation layer 304, may maintain a standoff distance between adjacent layers 302 and 304, particularly under compressive forces that may be asserted by ceramic through-bolts 306.

FIG. 4 is front view of intermediate insulation layer 304 of thermal insulation, according to some embodiments. Generally, reducing area of layer 304 also reduces contact area with refractory metal foil layers 302 and thus may reduce heat conductive paths. The area reduction may be made by including holes 402 in the intermediate insulation layer material, which may be zirconia felt. Though holes 402 are illustrated as circles, other shapes may be used and claimed subject matter is not so limited.

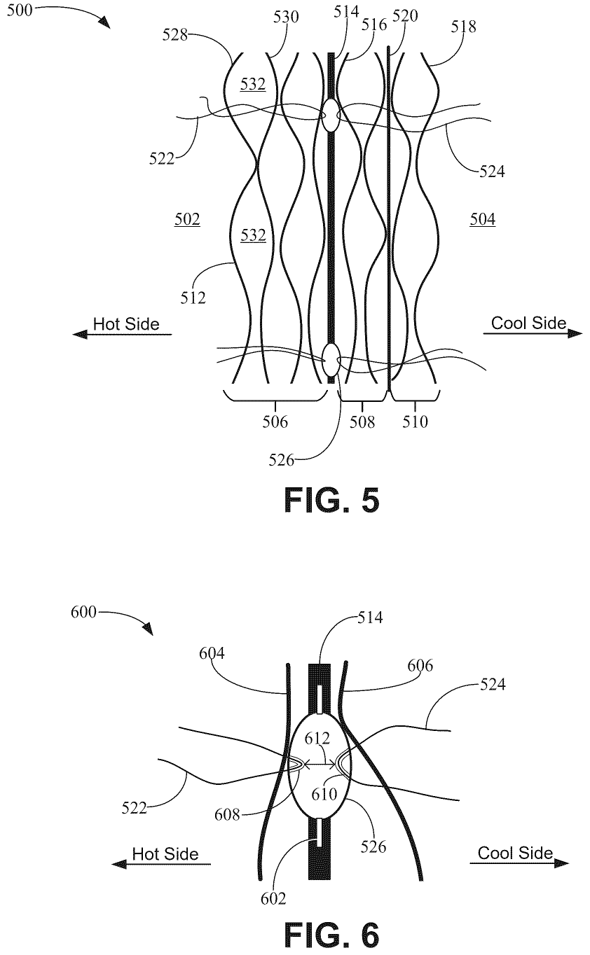

FIG. 5 is schematic cross-section diagram of a portion 500 of thermal insulation, according to some embodiments. Relative sizes in the figure are not necessarily drawn to scale and may be exaggerated for clarity. For example, portion 500 may be the same as or similar to portion 122 of insulation 106. Referring to the figure for the following example, the left side is the hot temperature side such that during operation of the insulation, a temperature in region 502 may be greater than 1000 degrees Celsius. In some cases, temperatures in this region may be as high as 2000 degrees Celsius. A temperature in region 504 may be much cooler, at less than several hundred degrees, for example.

The insulation may be considered to have a hot zone portion 506, a mid-temperature zone portion 508, and a low temperature zone portion 510. Materials (e.g., refractory metal foils) in hot zone portion 506 have properties that allow them to withstand the very high temperatures of region 502. Materials in the insulation may be subjected to increasingly cooler temperatures with increasing distance from region 502. Accordingly, materials in mid-temperature zone portion 508 need not have properties that allow them to withstand the very high temperatures of region 502 but nevertheless may be configured (e.g., selected) to be able to withstand relatively high temperatures, such as in a range of about 400 to 1000 degrees Celsius. Low temperature zone portion 510, farthest from hot region 502, like materials in mid-temperature zone portion 508, need not have properties that allow them to withstand the very high temperatures of region 502. Instead, materials in the low temperature zone portion may be selected based on their low mass and volume, for example. For example, materials in low temperature zone portion 510 may be MLI materials such as polyester polyamide foils, which have relatively low mass and volume and perform well at temperatures below about 400 degrees Celsius.

In various implementations, the insulation of portion 500 includes multiple refractory metal foil layers 512 disposed in hot zone portion 506. An insulating transition layer 514 may separate hot zone portion 506 and mid-temperature zone portion 508. Layers 516 disposed in mid-temperature zone portion 508 may comprise non-metal substrates (e.g., Kapton or Mylar with metal coatings). Layers 516 may also include stainless steel foil, tungsten foil, or titanium foil, which has a relatively low emissivity.

General MLI materials 518, such as polyester polyamide foils, may be disposed in low temperature zone portion 510. In some implementations, a zirconia felt layer 520 may be placed among layers in mid-temperature zone portion 508 and/or low temperature zone portion 510. Insulating transition layer 514 may be zirconia felt, which is a flexible, lightweight and thin (e.g., 50 mils) layer material that can withstand temperatures as high as 2000 degrees Celsius.

In some embodiments, refractory metal threads may be used, at least in part, to hold the various layers of the insulation together. Unfortunately, metal threads that traverse through multiple insulating layers are relatively good heat conductors and thus provide a path for heat to flow across the insulating layers. In some implementations, a ceramic button, which is described below, can interrupt the heat flow path of a metallic wire. Accordingly, instead of a single metal thread traversing all layers of insulation, a ceramic button may be used to tie one metal thread in one part of the insulation to another metal thread in another part of the insulation. For example, in hot zone portion 506, a first metal thread 522 that penetrates at least some of refractory metal foil layers 512 may be configured to at least partially hold the refractory metal foil layers together. In mid-temperature zone portion 508 and low temperature zone portion 510, a second metal thread 524 that penetrates at least some of layers 516, 518, and 520 may be configured to at least partially hold these layers together. In some cases, the metal threads may be molybdenum wire. In various embodiments, first and second metal threads 522 and 524 may be retained at one of their respective ends by a ceramic button 526, which may be disposed on insulating transition layer 514. Ceramic buttons 526 may act as standoffs that help to at least partially maintain separation between layers. Also, ceramic buttons 526 may be configured to retain a termination of the metal thread, which may be configured in a loop or in a single pass. A loop configuration is illustrated in the figure. In this configuration, ceramic button 526 may include a through-hole for a metal thread to be passed (e.g., “threaded”) through by entering one end of the hole and exiting the other end of the hole. This is described below. In another configuration, a metal thread (e.g., 522 and 524) may be embedded in ceramic button 526. For example, the embedding may occur during fabrication of the ceramic button such that it is cast or formed with a metal thread therein. Or the metal thread may be inserted and adhered in a hole in the ceramic button.

As mentioned above, metal threads tend to be a good heat conductor and provide a heat conducting path from one insulation layer to the next insulation layer. There are generally two design features that may be used to reduce the heat conducting ability of a metal wire. First, its cross-sectional area may be reduced. Then it may be a tradeoff between reducing the wire's thermal conductivity and maintaining the wire's tensile strength, which may be important for holding the multiple MLI layers together, for example. A second design feature for reducing the heat conducting ability of a metal wire to transfer heat from one insulating layer to the next is to increase the length of the wire between the two insulating layers. For example, for all other things being equal, a coiled, curved, or bent wire between two layers will resist heat conduction more so than a straight wire. Accordingly, FIG. 5 illustrates that first metal thread 522 and second metal thread 524 may be curved or bent between adjacent layers. Such curving or bending of the wire may also contribute to the pliability of the insulation.

In some implementations, individual refractory metal foil layers 512 may have an undulating or “wrinkled” shape, as illustrated in the figure. Such nonplanar shapes may allow for gaps or spacings between adjacent foil layers 512. For example, refractory metal foil layer 528 is adjacent to refractory metal foil layer 530 with spacings 532 therebetween. Such spacings prevent direct conductive thermal paths between the adjacent foil layers. In these spacing regions, heat conduction may be made by radiative transfer between the foil layers. Accordingly refractory metal foil layers 512 may be selected so as to have a relatively low emissivity. In some implementations, spacings 532, and the concomitant reduction in contact between adjacent foil layers, may be formed and retained by embossing the foil layers together. In other implementations, spot welding may be used to join together the contact portions of the adjacent layers. In any case, metal-to-metal contact, such as between refractory metal foil layers 528 and 530, generally creates a thermal short. Thus, avoiding direct contact or making purposeful contact between adjacent metal layers may be a tradeoff between increasing resistance to heat flow versus structural stability of the insulation.

As mentioned above, portion 500 may be part of insulation 106, which may be flexible. For example, insulation 106 may be a blanket insulation that can be wrapped around (e.g., under, over, etc.) the object (e.g., 102) that is to be insulated. The general structure of insulation 106, such as the loose layering (e.g., embossing) of the refractory metal foil layers 512, the retention of the layers by threads, and so on, contribute to its bendability and pliability. In contrast, some forms of MLI insulation that include refractory metal foil layers may be less bendable and pliable if these forms of insulation include relatively rigid (or less flexible) elements. Though such insulation may not be easily wrapped around objects, this type of insulation (e.g., 206) may be structurally self-supporting. For example, in some implementations, a high-temperature MLI may include, instead of or in addition to metal threads, a ceramic rod (e.g., 306) that penetrates at least some of the refractory metal foil layers and is configured to at least partially hold the refractory metal foil layers together. The high-temperature MLI may further include a zirconia felt layer between the refractory metal foil layers. The zirconia felt layer may include apertures to reduce the mass of the zirconia felt layer. In various implementations of portion 500, insulating transition layer 514 may be a zirconia felt. Refractory metal foil layers 512, which may be molybdenum, may be embossed or may be spot-welded to one another.

FIG. 6 is a close-up view of a ceramic button portion 600 of thermal insulation, according to some embodiments. Relative sizes in the figure are not necessarily drawn to scale and may be exaggerated for clarity. Hot and cool sides of the insulation (e.g., during operation) are indicated in the figure. Button portion 600 may be the same as or similar to the upper button 526 and its surrounding region illustrated in FIG. 5. Ceramic button 526 may include attachment elements 602 to help insulating transition layer 514 (or what ever material is used) to hold the ceramic button. First metal thread 522 penetrates refractory metal foil layer 604 (e.g., which may be one of layers 512) and second metal thread 524 penetrates non-metal substrate layers 606 (e.g., which may be one of layers 516).

First metal thread 522 may be retained at one of its ends by ceramic button 526, which may be disposed on insulating transition layer 514. For example, ceramic button 526 may be configured to retain a termination of the metal thread, configured in a loop configuration, as illustrated in the figure. Ceramic button 526 may include through-hole 608 for first metal thread 522 to be passed through. In another configuration (not illustrated), a metal thread (e.g., 522 and 524) may be embedded in ceramic button 526. For example, the ceramic button need not include a through-hole and instead the end(s) of the metal thread may be “locked” in place in the ceramic button. Ceramic button 526 may also be configured to retain a termination of second metal thread 524, configured in a loop configuration. Ceramic button 526 may include a through-hole 610 for second metal thread 524 to be passed through. Double arrow 612 indicates the mass of ceramic button 526 that acts as thermal insulation between the first and the second metal threads. For example, this thermal insulation acts to prevent thermal short circuits that metal threads may otherwise create if they were to transit across all the layers of the insulation.

Both refractory metal foil layer 604 and non-metal substrate layer 606 are illustrated in the figure as being in contact with ceramic button 526. Generally, this may be the case but also these layers may not be in such contact. In some implementations, for at least the reason that the refractory metal foil layers and the non-metal substrate layers may be flexible, during a process of embossing or assembling these layers, at least occasionally there may be contact between the ceramic buttons (e.g., and/or insulating transition layer 514) and the adjacent layers.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A high-temperature multilayer insulation comprising:
a hot zone portion, a mid-temperature zone portion, and a low temperature zone portion;
refractory metal foil layers in the hot zone portion;
an insulating transition layer separating the hot zone portion and the mid-temperature zone portion; and
non-metal substrate layers in the mid-temperature zone portion and the low temperature zone portion.

2. The insulation of claim 1, further comprising a metal thread that penetrates at least some of the refractory metal foil layers and is configured to at least partially hold the refractory metal foil layers together.

3. The insulation of claim 2, further comprising a ceramic button disposed on the insulating transition layer and configured to retain a termination of the metal thread.

4. The insulation of claim 2, wherein the metal thread is molybdenum.

5. The insulation of claim 1, further comprising a ceramic rod that penetrates at least some of the refractory metal foil layers and is configured to at least partially hold the refractory metal foil layers together.

6. The insulation of claim 1, further comprising a zirconia felt layer between the refractory metal foil layers.

7. The insulation of claim 6, wherein the zirconia felt layer includes apertures configured for a mass reduction of the zirconia felt layer.

8. The insulation of claim 1, wherein the insulating transition layer is a zirconia felt.

9. The insulation of claim 1, wherein the refractory metal foil layers are embossed.

10. The insulation of claim 1, wherein the refractory metal foil layers are spot-welded to one another.

11. The insulation of claim 1, wherein the refractory metal foil layers are molybdenum.

12. The insulation of claim 1, wherein the hot zone portion is configured to operate at temperatures above about 1000 degrees Celsius, the mid-temperature zone portion is configured to operate at temperatures between about 1000 and 400 degrees Celsius, and the low temperature zone portion is configured to operate at temperatures below about 400 degrees Celsius.

13. The insulation of claim 1, wherein the non-metal substrate layers comprise Kapton or Mylar.

14. A high-temperature multilayer insulation comprising:
refractory metal foil layers;
non-metal substrate layers; and
an insulating transition layer separating the refractory metal foil layers and the non-metal substrate layers.

15. The insulation of claim 14, further comprising a metal thread that penetrates at least some of the refractory metal foil layers and is configured to at least partially hold the refractory metal foil layers together.

16. The insulation of claim 15, further comprising a ceramic button disposed on the insulating transition layer and configured to retain a termination of the metal thread.

17. The insulation of claim 15, wherein the metal thread is molybdenum.

18. The insulation of claim 14, further comprising a ceramic rod that penetrates at least some of the refractory metal foil layers and is configured to at least partially hold the refractory metal foil layers together.

19. The insulation of claim 14, further comprising a zirconia felt layer between the refractory metal foil layers.

20. The insulation of claim 14, wherein the refractory metal foil layers are molybdenum.
